(19) United States
(12) Patent Application Publication
(10) Pub. No.: US 2005/0135108 A1
(43) Pub. Date: Jun. 23, 2005

(54) Adaptive universal drop light hanger system

(76) Inventor: Peter George Delano, Amston, CT (US)

Correspondence Address: Peter G. Delano, 23 Uncas Dr., Amston, CT, 06231, US

(21) Appl. No.: 10/741,606

(22) Filed: Dec. 19, 2003

(51) Int. Cl. F21V 21/00

(52) U.S. Cl. 362/396; 362/399; 362/400

(57) ABSTRACT

A system for hanging a drop light from a wide variety of irregularly shaped objects at varying angles and orientations while providing superior stability, and greater freedom of choice for hanging locations. The hanger system is comprised of a plurality of flexible hangers grouped together and mounted to a drop light, which when forced over an object, tend to deflect snapping back into their preferential shape in accordance with the geometry of the object. As the flexible hangers snap back into their preferred position over the object they provide secure and stable support for the drop light. As the drop light is removed the flexible hangers deflect out of their grasping shape sliding past the mounting object allowing removal from the mounting object.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

1. Field of Invention

This invention relates to drop lights and more particularly to an apparatus for securely hanging a drop light in a stable manner from an object at any desired orientation.

2. Description of Prior Art

Drop lights are conventionally used to illuminate otherwise difficult to light work areas. Commonly used to light the underside of a car or engine compartment, drop lights represent portable light for hard to reach areas. These drop lights are equipped with a fastening device, usually a rigid hook, to hang the drop light from a suitable object in proximity to the work area. Drop lights consist of an electric light, either fluorescent or a traditional filament bulb, protected by a shield and cage and mounted to a handle. Power is supplied from an extension cord and routed through the handle or housing to light the bulb.

Finding a suitable structure to hang a drop light from is a significant problem. Drop lights very frequently fall from the object they have been hanged from. Often, the object which the drop light has been hanged from does not adequately lend itself to support with respect to the geometry of fastening device, or hook. Furthermore, if a suitable object is available it may not be in the correct location or orientation to illuminate the desired area. Often times an individual is left with an unstable mounting and poorly lit work area with a drop light directing light into their eyes. An insecure mounting often exists when the hook does not sufficiently loop around the mounting object. Under these conditions the drop light is not hooked to its mounting object but rather balanced on it. When a drop light is insecurely mounted it subsequently falls, resulting in failure of the bulb. Special light bulbs are sold, known as rough service bulbs, which are usually required for drop lights due to the very common occurrence of dropping a drop light.

It is imperative that a drop light be securely fastened and oriented in such a manner as to illuminate the work area to an acceptable degree while shielding the eyes of the user. The common fastening system, a rigid hook falls short due to its inability to grasp many objects, lack of stability, and its fixed orientation. It would therefore be highly desirable for a drop light to consist of a hanging system which affords the user as much freedom of choice with respect to mounting objects as possible. Providing the user both stable, convenient and adequately located mounting opportunities.

In an attempt to alleviate these problems several prior art inventions have been equipped with apparatus and schemes to provide adjustable hooks. For example U.S. Pat. No. 5,713,658 to Stranagan provides a rotatable hook and mount which attaches to and holds a fluorescent drop light at a desired angle. To adjust the hook, a threaded nut is loosened allowing the user to orient the hook to one of several slots on the mount. Once the desired location is reached the nut can be retighten securing the light. However, this approach relies on the availability of an acceptable feature within range of the work area to secure the hook to and requires significant apparatus and effort to adjust orientation.

U.S. Pat. No. 5,213,412 awarded to Ciallella discloses a hook assembly and a magnet that are alternatively selectable. A removable and replaceable cap is provided that contains a hook. When the magnet is used to hang the drop light, the cap is removed and the magnet is employed. In order to use the hook, the removable cap must be replaced and the drop light can be hung from the hook. Although, this disclosure attempts to address the fundamental problem of finding suitable mounting surfaces it does not sufficiently do so. Magnets require flat, rigid, and magnetic surfaces to adequately support weight. These conditions rarely exist in a sufficient manner as to facilitate the support of a drop light, under the conditions in which they are used. Often, magnetic surfaces are not flat or are not within an acceptable range of the work area. Furthermore, a surface that would be in proximity to the work area may not be magnetic at all. The implementation of the hook has all the shortcomings as described above and in this application, a removable hook could be lost leaving only the magnet for support.

U.S. Pat. No. 4,305,120 to Lacinski provides a means for a rotatable hook positioned at the top of a drop light. This hook can be rotated by means of a complicated apparatus integrated to the support structure of the hook. U.S. Pat. No. 5,568,968 to Jaramillo provides a hook apparatus integrated with a magnet. This system is connected to the drop light by a sliding track allowing for orientation adjustment of the hook and magnet. These disclosures provide means to adjust the orientation of the hook, or magnet, by relatively complicated means involving several components and mechanisms. However they still fail to address the overriding problem of obtaining a suitable mounting object and providing a stable fastening device.

None of the above inventions taken either singly or in combination tend to solve the overriding problem of suitably supporting a drop light in proximity to a work area with the desired illumination effect from any available mounting object. All of the above mentioned applications fall short of the objective in one or all of the following conditions:
(a) An ideal mounting surface is required for the invention to function.
(b) A suitable object for securing a rigid hook is required, with fixed geometry, a rigid hook cannot afford mounting support if the mounting object is not ideal.
(c) A substantial amount of apparatus or mechanism is required in order to adjust and secure the hook for mounting.
(d) A substantial amount of effort is required, by the user in order to adjust the mounting feature.
(e) A mounting object that meets the limited parameters as to function well with a rigid hook, or magnetic type hanging system needs to be found within proximity to the work area.
(f) Materials required for construction may require the uses of relatively dense materials, such as steel, resulting in a heavy and bulky design making the task of hanging a droop light more difficult.

### SUMMARY

The present invention provides an improved, convenient, simple, cheap and light weight hanger system for securing a drop light. The improvement is that a drop light can be attached to a wider range of objects at any desired orientation in a stable and secure manner. Objects, which would have previously been found unacceptable for suspension of drop light, can now easily be utilized.

### OBJECTS AND ADVANTAGES

Accordingly several objects and advantages of the present invention are:
(a) to provide a hanger which can positively grasp, and subsequently, hang a drop light from objects that would previously be found insufficient or inadequate;
(b) to enable the suspension of a drop light at any desired angle as to provide adequate light to illuminate a work area;
(c) to improve upon the stability afforded to a drop light when mounted to objects for the purposes of positioning, placing, or hanging;
(d) to achieve the object of this invention in an extremely simple, light weight, and efficient manner without the complicated apparatus and mechanics of previous art;

Further objects and advantages will become apparent from a consideration of the ensuing drawings and description.

### DESCRIPTION OF DRAWINGS

The invention will be better understood with respect to the above objects as well as objects other than those explicitly detailed above after a study of the following description.

FIG. 1 is a perspective view of the present invention integrated with a drop light;

FIG. 2 is an enlarged view of the embodiment of the invention shown in FIG. 1;

FIG. 3 is an enlarged view of an individual component of the embodiment of the invention along with an illustration of its deflected shape during the transient insertion over a mounting object;

FIG. 4 is an enlarged view of an individual component of the embodiment of the invention along with an illustration of its deflected shape during the transient removal from a mounting object.

### REFERENCE NUMERALS IN DRAWINGS

10 hanger system
12 individual flexible hangers
14 drop light housing
16 drop light
18 light bulb
20 protective cage
22 light shield
24 handle
26 power cord
28 deflected hanger during installation
30 deflected hanger during removal

### DESCRIPTION OF INVENTION

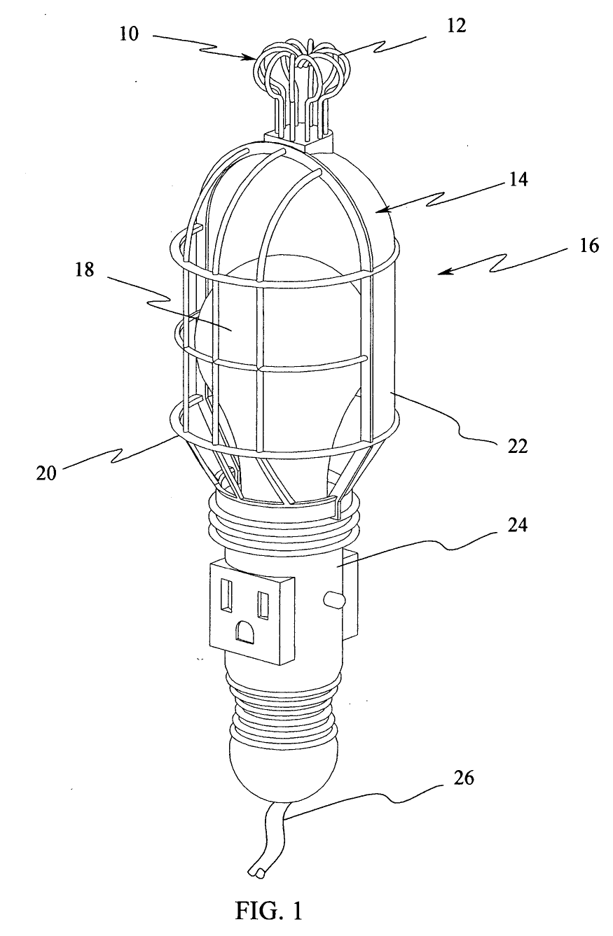

Referring now to FIG. 1, the hanger apparatus of the present invention is illustrated generally as hanger system 10. Hanger system 10 consists of a plurality of individual flexible hangers 12. One end of hanger system 10 is fixedly secured to housing 14 of drop light 16. Housing 14 consists of a light shield 22 connected to a protective cage 20. Housing 14 works in combination with shield 22 and cage 20 in order to direct light and protect light bulb 18, respectively. Housing 14 is connected to handle 24, which provides a grasping surface for the user. Power cord 26 is connected to handle 24 in order to provide power for bulb 18.

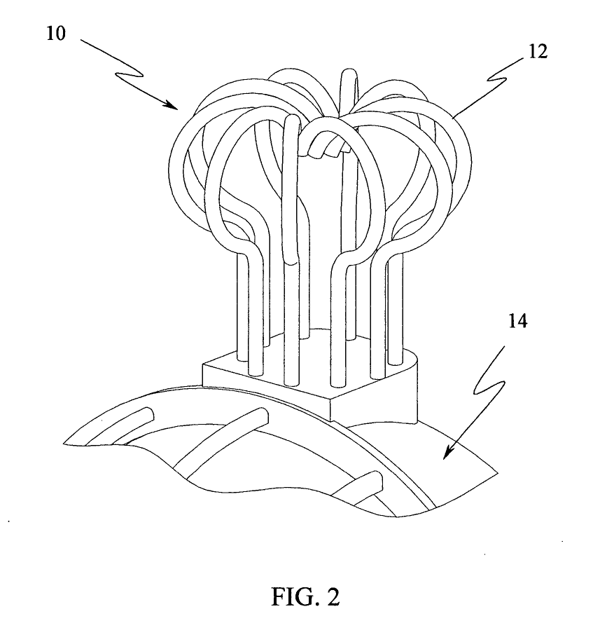

Referring now to FIG. 2, hanger system 10 of the present invention, consists of a plurality of individual flexible hangers 12 each connected at one end to housing 14. Each individual flexible hanger 12 is mounted to housing 14 of drop light 16. Each flexible hanger 12 has a similar shape, which can be described as a hook.

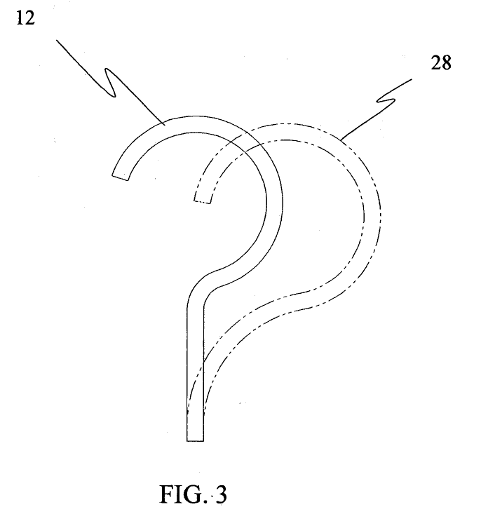

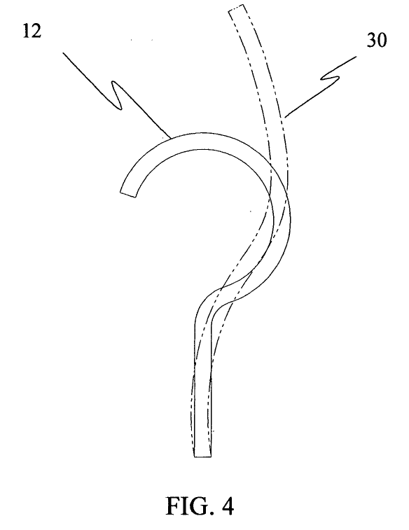

Operation—FIGS. 3, 4

Referring now to FIG. 3, individual flexible hanger 12 is shown in two states of operation. Deflected hanger 28 illustrates the form flexible hanger 12 would take during the transient application of drop light 16 over a mounting object. As drop light 16 is grasped by handle 24 and guided towards a mounting object, hanger system 10 engages the mounting object. As force is applied to hanger system 10, through housing 14 and handle 24, each flexible hanger 12 deflects accommodating the mounting object's geometry, approximating the shape of deflected hanger 28. Deflected hanger 28 is schematic in nature and its actual geometry would be dependent on the geometry the mounting object it is being forced over. Hanger system 10 is meant to function as a system of elements, each individual deflected hanger 28 complying to and accommodating any geometry. As hanger system 10 is further engages the mounting object an equilibrium is reached where each deflected hanger 28 snaps back to its preferred geometry, hanger 12. Depending on the geometry of the mount object some hangers will snap fully back into their preferred shape, hanger 12, and others will remain in deflected shape 28. It is this state of hanger system 10, achieved after passing over a mounting object, that effects the overall objective of the present invention, providing an improved mounting system for supporting drop light 16. Once again, it should be noted that it is the plurality of individual hangers 12, encompassing hanger system 10, which work together and allow drop light 16 to be hanged from a very diverse range of mounting objects. In addition since hanger system 10 consists of a plurality of flexible hangers 12, drop light 16 can be suspended from an object at any angle, as the symmetric nature of hanger system 10 has no preferential orientation.

Referring now to FIG. 4, in order to remove drop light 16 from a mounting object, flexible hangers 12 deflect into the approximate geometry of deflected hanger 30. Operating in the converse as described in the above installation, drop light 16 is pulled away from a mounting object. While drop light 16 is being removed and hanger system 10 disengages the mounting object, each individual flexible hanger 12 deflects to the approximate shape of deflected hanger 30. The geometry of deflected hanger 30 allows hanger system 10 to pass over the mounting object. The force required to remove drop light 16 is greater than the total weight of drop light 16 and its power cord 26. As hanger system 10 passes over the mounting object the plurality of deflected hangers 30 spring back to the preferred embodiment geometry of individual flexible hanger 12. It is the flexibility and adaptive nature that allow hanger system 10 to support drop light 16 from a greater variety of mounting objects and with greater adaptability than prior art.

It will occur to those skilled in the art that many modifications and variations of hanger system 10 may be made without departing from the spirit of the invention. Some of these will be discussed.

It would be possible to mount hanger system 10 to a location on drop light 16 other than the top, increasing the possibilities for orientation of drop light 16. It would also be possible to provide a means to remove and relocate hanger system 10 to several locations on drop light 16, further increasing the potential for orientation. Also the number, spacing, precise geometry, flexibility and strength of flexible hangers 12 with respect to their integration with hanger system 10 could be varied in order to optimize the griping capability of the hanger system 10. It would also be possible to integrate hanger system 10 into variations of the form of drop light 16, such as a fluorescent type drop light. Combination of hanger system 10 with any of the prior art inventions would also be possible. It would also be possible to integrate hanger system 10 into a wide variety of objects or articles whereby the overall object of hanger system 10 would benefit such an object.

Advantages

From the description above a number of advantages for the invention disclosed herein can become evident. This invention provides an improved hanger system for drop lights, which is superior to previous art in the following areas;
(a) It consists of a plurality of flexible hangers which act as a system with the capability of adapting to any geometry and supporting a drop light.
(b) It permits the suspension of a drop light from a far greater variety of objects and with greater stability thereby improving an individuals ability to position a drop light and illuminate a work area.
(c) It allows for a drop light to be oriented at any angle with respect to the object from which it is being suspended.
(d) It is exceedingly simple consisting of no moving parts and can be easily manufactured and assembled at minimal increase in cost over the whole drop light itself.
(e) It can be manufactured from light weight materials, such as plastic, which hold a weight advantage over previous art.
(f) It offers a means for securing objects to irregularly shaped surfaces such as those often found in work areas.

Although the description above contains many specifics these should not be construed as limiting the scope of the invention but merely providing illustrations of some of the presently preferred embodiments of the invention. The specific make-up and shape of the hanger system could be varied as to optimize performance. Examples given above and depicted in the accompanying figures illustrate flexible hangers as following the general shape of a hook. It may be discovered through empirical means that a slightly different shape performs best. The hanger system described herein could be integrated to a wide variety of objects whereby they would benefit from its application.

Thus the scope of this invention should be determined by the appended claims and their legal equivalents, rather than be the examples given.

1. A means for positively hanging a drop comprising:
a. a plurality of flexible hangers mounted to the top of said drop light
b. said flexible hangers mounted to said drop light in proximity to one another as to act as a system interacting with one another
c. sufficient flexibility within said hangers as to adapt to a irregularly shaped mounting object deflecting but not permanently deforming
d. ample strength and adequate geometry as to support the drop light after the flexible hangers have been engaged upon said mounting object
e. suitable flexibility as to allow the removal of said drop light from the mounting object with sufficient resilience as to return to their original shape

2. The hanger system of claim 1 incorporated into a drop light in a manner
a. other than at the location described
b. in a plurality of locations on said drop light
c. with varying geometry and numbers

3. The hanger system of claim 1 incorporated into objects other than those described in claim 1 with the intended function of claim 1.
